(19) United States
(12) Patent Application Publication
(10) Pub. No.: US 2023/0264509 A1
(43) Pub. Date: Aug. 24, 2023

(54) DISPENSING STRUCTURE AND DISPENSING ASSEMBLY

(71) Applicant: 3M INNOVATIVE PROPERTIES COMPANY, St. Paul, MN (US)

(72) Inventor: In-Hwan Lee, Gyeonggi-do (KR)

(21) Appl. No.: 18/017,540

(22) PCT Filed: Jul. 27, 2021
(86) PCT No.: PCT/IB2021/056822

§ 371 Date: Jan. 23, 2023

Related U.S. Application Data
(60) Provisional application No. 63/058,170, filed on Jul. 29, 2020.

(51) Int. Cl. B42D 5/00; G09F 3/10

(52) U.S. Cl. CPC B42D 5/005; G09F 3/10

(57) ABSTRACT

A dispensing structure (102) includes a housing member (112) defining a hollow space adapted to receive a stack (104). The housing member includes a first retention member (132) and a second retention member (140). The first retention member includes a first plate and a second plate longitudinally spaced apart from the first plate such that a slot (138) is defined therebetween. The second retention member defines an aperture (141) therethrough. The housing member is adapted to rotate relative to a base member (154). The base member includes a first portion (156) slidably received through the aperture of the second retention member, and a second portion (168). The second retention member is adapted to move towards the second portion based on removal of at least one of notes and flags from the stack.

The present disclosure relates to a dispensing structure and a dispensing assembly, and specifically, to the dispensing structure and the dispensing assembly for dispensing notes or flags.

### BACKGROUND

Conventionally, a dispensing structure, such as single pop-up dispensers for notes or flags, may include a complex design having a number of structural components. For example, the dispensing structure may include one or more springs. The springs facilitate single dispensing of the notes or flags and/or allow mounting of the dispensing structure to a support surface. Further, in some designs, the dispensing structure may be provided with a heavy element such as a metallic weight to fix and anchor the dispensing structure to the support surface. Such additional components may increase a weight, size, and cost of the dispensing structure. Thus, there is a need for an improved dispensing structure and assembly that addresses one or more of the above stated concerns.

### SUMMARY

Generally, the present disclosure relates to a dispensing structure and a dispensing assembly. There is a need for dispensing assemblies that are compact in size, light in weight, and cost effective. Accordingly, the dispensing structure described herein includes a simple and an ergonomic design. Further, the dispensing structure includes a self-pop-up mechanism and has fewer components compared to conventional dispensing structures. The dispensing assembly eliminates usage of springs, weights, and the like, which may reduce cost, size, and weight of the dispensing structure.

In one aspect, there is provided a dispensing structure adapted to be removably coupled with a support structure. The dispensing structure includes a housing member defining a hollow space adapted to receive a stack of a plurality of at least one of notes and flags removably adhered to each other. The housing member includes a first retention member including a first plate and a second plate longitudinally spaced apart from the first plate such that a slot is defined therebetween, wherein at least one of the notes and the flags of the stack is adapted to pass through the slot. The first plate and the second plate resiliently engage with the stack. The housing member also includes a second retention member defining an aperture therethrough, the second retention member being laterally spaced apart from the first retention member to define the hollow space therebetween. The dispensing structure also includes a base member adapted to be coupled to the housing member, wherein the housing member is adapted to rotate relative to the base member. The base member includes a first portion slidably received at least partially through the aperture of the second retention member, the first portion defining a first end proximate the stack and a second end distal to the stack. The base member also includes a second portion disposed on the support structure and coupled to the first portion proximate the second end of the first portion, wherein the second retention member is adapted to move towards the second portion based on removal of at least one of the notes and the flags from the stack.

In another aspect, there is provided a dispensing assembly. The dispensing assembly includes a dispensing structure adapted to be removably coupled with a support structure. The dispensing structure includes a housing member defining a hollow space. The housing member includes a first retention member including a first plate and a second plate longitudinally spaced apart from the first plate such that a slot is defined therebetween, and wherein the first plate and the second plate resiliently engage with the stack. The housing member also includes a second retention member defining an aperture therethrough. The second retention member being laterally spaced apart from the first retention member to define the hollow space and at least one side opening therebetween. The at least one side opening is in communication with the hollow space. The dispensing structure also includes a base member adapted to be coupled to the housing member. The base member includes a first portion slidably received at least partially through the aperture of the second retention member., the first portion defining a first end proximate the stack and a second end distal to the stack. The base member also includes a second portion disposed on the support structure and coupled to the first portion proximate the second end of the first portion. The dispensing assembly further includes a stack of a plurality of at least one of notes and flags removably adhered to each other. The stack is adapted to be received within the hollow space defined between the first retention member and the second retention member through the at least one side opening.

The details of one or more embodiments of the disclosure are set forth in the accompanying drawings and the description below. Other features, objects, and advantages of the invention will be apparent from the description and drawings, and from the claims.

### BRIEF DESCRIPTION OF DRAWINGS

Like symbols in the drawings indicate like elements. Dotted lines indicate optional or functional components, while dashed lines indicate components out of view.

FIG. 1 illustrates a perspective view of a dispensing assembly including a dispensing structure and a stack of notes disposed within the dispensing structure, in accordance with some embodiments discussed herein;

FIG. 2 illustrates a perspective view of the dispensing structure of FIG. 1 and a stack of flags disposed in the dispensing structure, in accordance with some embodiments discussed herein.

FIG. 3 illustrates an exploded view of the dispensing structure of FIG. 1, in accordance with some embodiments of the present disclosure.

FIG. 4 illustrates a side view of the dispensing assembly, in accordance with some embodiments discussed herein.

FIG. 5 illustrates a side view of the dispensing assembly of FIG. 1 wherein multiple notes are removed from the stack, in accordance with some embodiments discussed herein.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the context of present disclosure, the terms “first”, “second”, “third”, and “fourth” are used as identifiers. Therefore, such terms should not be construed as limiting of this disclosure. The terms “first”, “second”, “third”, and “fourth” when used in conjunction with a feature or an element can be interchanged throughout the embodiments of this disclosure.

The present disclosure relates to a dispensing structure and a dispensing assembly that may be used for single dispensing of notes, flags, and the like. The dispensing structure includes a housing member and a base member that allow single dispensing of notes or flags. Further, the base member allows removably coupling of the dispensing structure with various support structures which may improve usability of the dispensing assembly. The dispensing assembly may be compact in size, light in weight, and cost effective. Further, the dispensing structure includes fewer components and a simplified design.

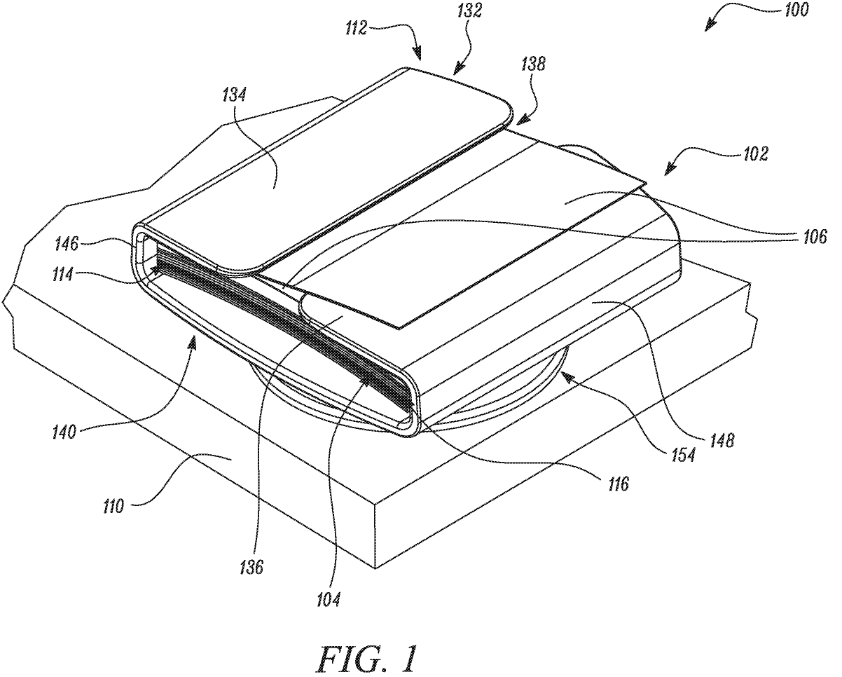

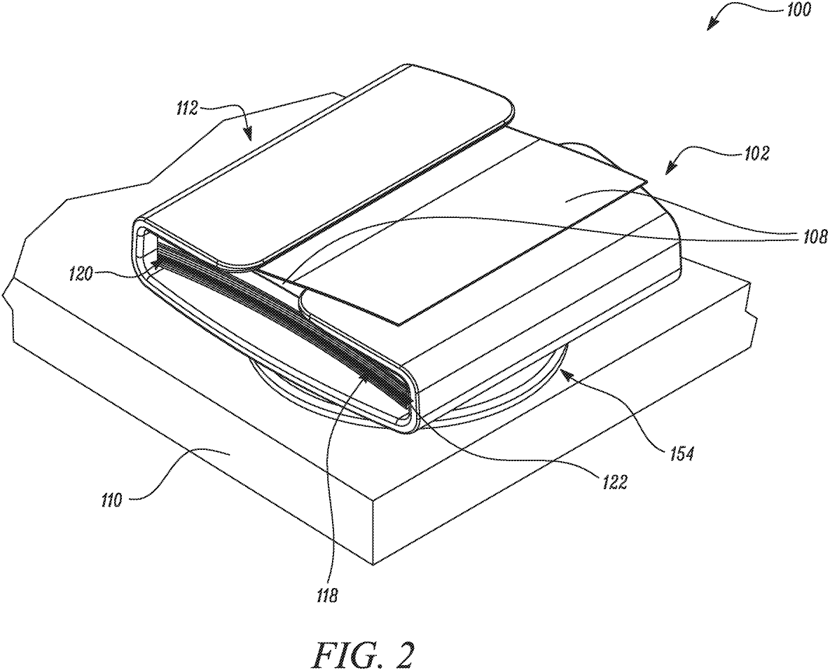

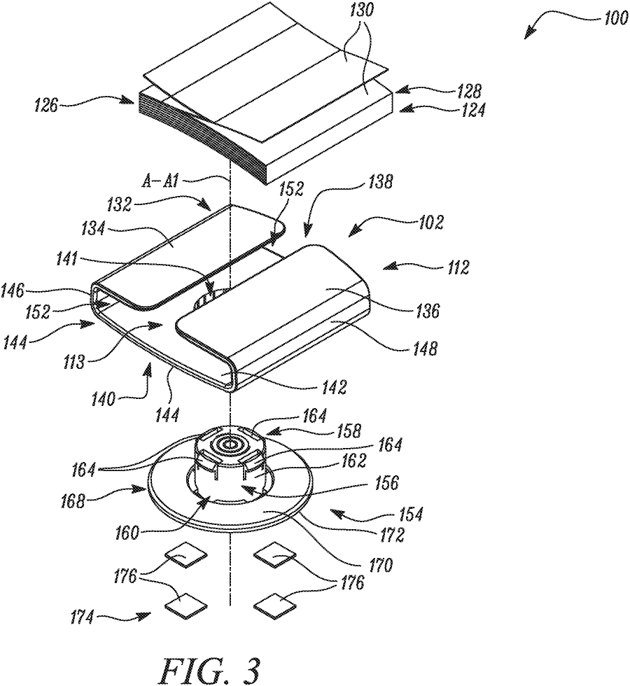

FIG. 1 is a perspective view of a dispensing assembly 100. The dispensing assembly 100 includes a dispensing structure 102 and a stack 104 of a plurality of at least one of notes 106 and flags 108 (shown in FIG. 2) removably adhered to each other. The dispensing structure 102 is adapted to be removably coupled with a support structure 110. The support structure 110 may be embodied as a desk, a partition/privacy panel, a cubicle wall, and the like. The dispensing structure 102 includes a housing member 112 defining a hollow space 113 (shown in FIG. 3) adapted to receive the stack 104 of the plurality of at least one of the notes 106 and the flags 108 removably adhered to each other. Further, in the illustrated example, the stack 104 is a pad having a plurality of notes 106. The stack 104 may include multiple similarly shaped and sized notes 106. Each note 106 of the stack 104 is interleaved with an adjacent note 106. The stack 104 includes a first side 114 and a second side 116. Further, in this embodiment, an adhesive is applied to the first side 114 of the stack 104 to bind the notes 106 securely together. Alternatively, the adhesive may be applied to the second side 116 of the stack 104 to bind the notes 106 securely together. In some examples, the notes 106 may be assembled in a z-stack (for example, the stack 124 shown in FIGS. 3 to 5), such that the adhesive of each note 106 is positioned at alternating sides 114, 116 of the stack 104 of the notes 106.

Referring to FIG. 2, the dispensing assembly 100 may be used to hold the flags 108. More particularly, the dispensing assembly 100 is used to hold a stack 118. The stack 118 is a pad having a plurality of flags 108. The stack 118 includes a first side 120. The stack 118 further includes a second side 122. The stack 118 is received within the dispensing structure 102. Further, in this embodiment, an adhesive is applied at the first side 120 of the stack 118 to bind the flags 108 securely together. Alternatively, the adhesive may be applied at the second side 122 of the stack 118 to bind the flags 108 securely together or the adhesive may be positioned at alternating sides 120, 122 of the stack 118 of the flags 108.

FIG. 3 illustrates an exploded view of the dispensing assembly 100. The dispensing assembly 100 includes a stack 124. The stack 124 is embodied as the z-stack herein. The stack 124 includes a first side 126 and a second side 128. Hereinafter, the first side 126 and the second side 128 are collectively referred to as alternating sides 126, 128. The stack 124 includes a plurality of notes 130. The notes 130 are assembled in the stack 124 such that the adhesive of each note 130 is positioned at alternating sides 126, 128 of the stack 124. In this embodiment, the note 130 may be dispensed both from the first side 126 and the second side 128. It should be noted that the dispensing structure 102 for holding the stack 124 of the notes 130 will now be explained in detail with relation to FIGS. 3 to 5. However, it should be noted that the description provided below is equally applicable for holding the stack 118 of the flags 108, the stack 104 of the notes 106, or any other such stack, without limiting the scope of the present disclosure.

As shown in FIG. 3, the dispensing structure 102 defines an axis “A-A1”. The housing member 112 includes a first retention member 132. The first retention member 132 includes a first plate 134 and a second plate 136 longitudinally spaced apart from the first plate 134 such that a slot 138 is defined therebetween. At least one of the notes 130 and the flags 108 (see FIG. 2) of the stack 124 is adapted to pass through the slot 138. The first plate 134 and the second plate 136 resiliently engage with the stack 124. More particularly, the stack 124 is in contact with the first and second plates 134, 136 at all times.

The housing member 112 also includes a second retention member 140 defining an aperture 141 therethrough. The aperture 141 is circular in shape. The second retention member 140 is laterally spaced apart from the first retention member 132 to define the hollow space 113 therebetween. The second retention member 140 defines an inner surface 142 and an outer surface 144. Further, the housing member 112 includes a pair of side members 146, 148 adapted to connect the first retention member 132 with the second retention member 140. More particularly, the housing member 112 includes the first side member 146 that connects the first plate 134 with the second retention member 140. Further, the housing member 112 includes the second side member 148 that connects the second plate 136 with the second retention member 140. The side members 146, 148 are generally parallel to each other. It should be noted that the first plate 134, the second plate 136, and the side members 146, 148 together define the hollow space 113 of the housing member 112.

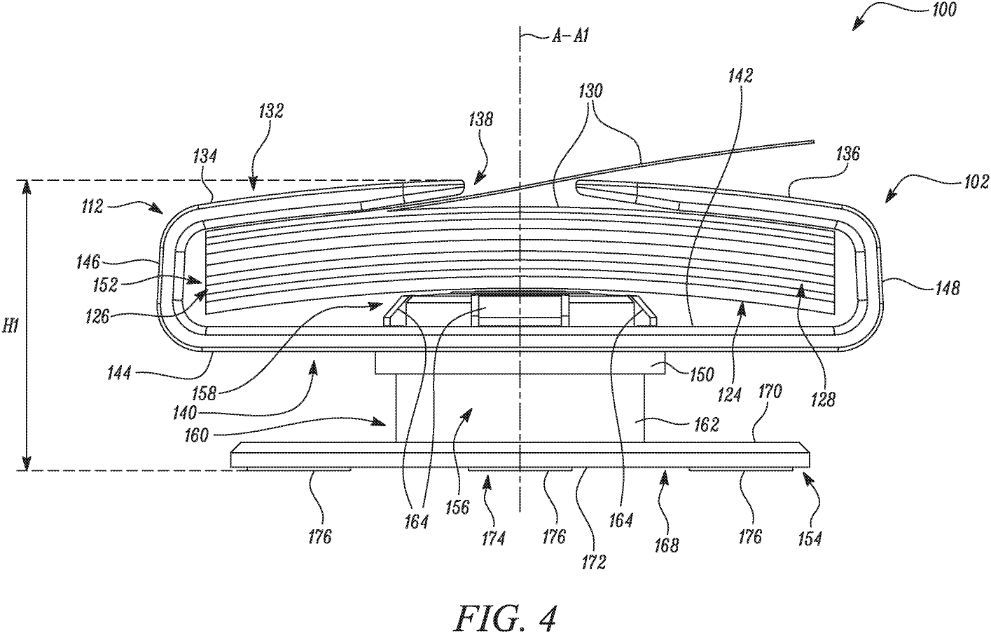

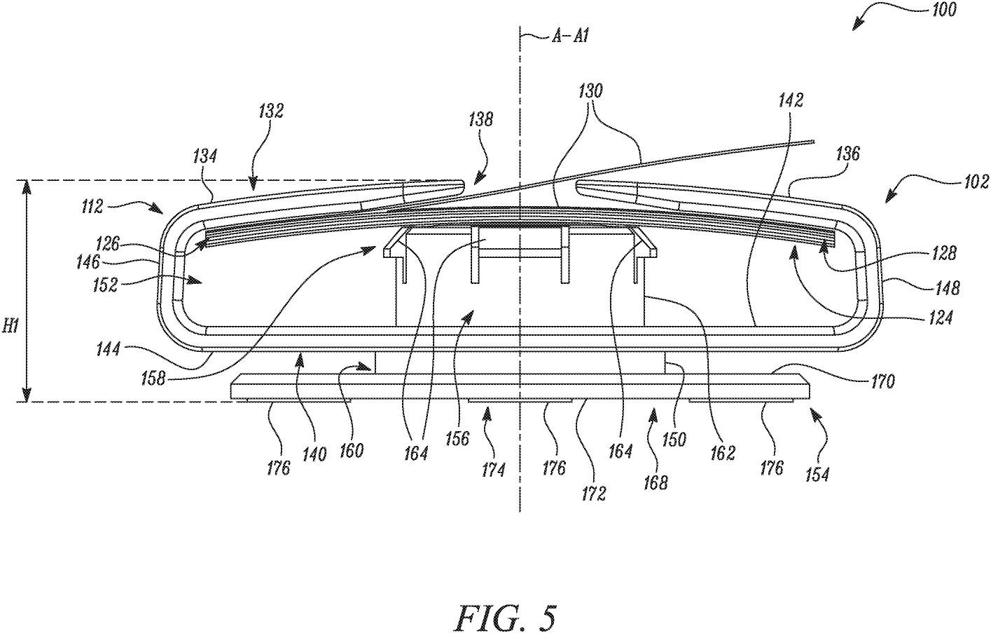

The housing member 112 includes a circular extension 150 (shown in FIGS. 4 and 5) that extends from the second retention member 140. In the illustrated example, the housing member 112 includes a single piece design. Further, the housing member 112 includes at least one side opening 152 in communication with the hollow space 113 for receiving the stack 124 therethrough. In the illustrated example, the housing member 112 includes a pair of side openings 152. The stack 124 may be introduced in the hollow space 113 through the side openings 152.

The dispensing structure 102 also includes a base member 154 adapted to be coupled to the housing member 112. The housing member 112 is adapted to rotate relative to the base member 154. Further, the housing member 112 is adapted to rotate about the axis “A-A1”. The base member 154 includes a first portion 156 slidably received at least partially through the aperture 141 of the second retention member 140. The first portion 156 defines a first end 158 proximate the stack 124 and a second end 160 distal to the stack 124. Further, the first portion 156 of the base member 154 is adapted to contact the stack 124 proximate the first end 158 of the first portion 156, such that the stack 124 is at least partially disposed between the first portion 156 and the first retention member 132. Moreover, the first portion 156 defines a surface 162. The first portion 156 is cylindrical in shape. It should be noted that a diameter of the aperture 141 may be greater than or equal to a diameter of the first portion 156 so that the first portion 156 can be slidable through the aperture 141 and the housing member 112 is rotatable relative to the base member 154. Further, a shape of the aperture 141 corresponds with a shape of the surface 162 of the first portion 156. In the illustrated example, the aperture 141 and the surface 162 are circular in shape. However, the aperture 141 and the surface 162 may include other shapes. Further, a length of the first portion 156 may be greater than a length of the housing member 112 so that the stack 124 can be held between the first portion 156 and the first retention member 132 even after removal of multiple notes 130 from the stack 124.

The first portion 156 includes a plurality of tabs 164 disposed proximate the first end 158 of the first portion 156. The plurality of tabs 164 engage with the second retention member 140 when the stack 124 is disposed within the hollow space 113. The plurality of tabs 164 disengages from the second retention member 140 upon movement of the second retention member 140 towards a second portion 168 of the base member 154. The plurality of tabs 164 project outwards from the surface 162 of the first portion 156. The plurality of tabs 164 are flexible in nature. Further, the plurality of tabs 164 allow coupling of the housing member 112 with the base member 154. The tabs 164 may compress to allow passage of the first portion 156 through the aperture 141 for coupling of the housing member 112 with the base member 154. Further, as the tabs 164 are flexible, the tabs 164 may assume their original form thereby allowing the base member 154 to engage with the housing member 112. In some examples, when the stack 124 includes a maximum permissible number of the notes 130, the plurality of tabs 164 engage with the inner surface 142 of the housing member 112.

The plurality of tabs 164 includes at least four tabs 164. The number of tabs 164 may vary as per application requirements. In some embodiments, the tabs 164 may be replaced by flexible snap fit connections to facilitate coupling between the housing member 112 and the base member 154. In other embodiments, protrusions may be present on the surface 162 of the first portion 156 which may allow engagement with the housing member 112.

The base member 154 includes the second portion 168 disposed on the support structure 110 (see FIG. 1) and coupled to the first portion 156 proximate the second end 160 of the first portion 156. The second retention member 140 is adapted to move towards the second portion 168 based on removal of at least one of the notes 130 and the flags 108 (see FIG. 2) from the stack 124. The second portion 168 is circular in shape. The second portion 168 defines a first surface 170 and a second surface 172. The first surface 170 is adapted to face the second retention member 140 when the base member 154 is coupled to the housing member 112. Further, the first surface 170 is coupled with the first portion 156. In the illustrated example, the base member 154 includes a single piece design. Alternatively. the first portion 156 may be coupled with the second portion 168 to form the base member 154.

Further, the dispensing structure 102 includes an adhesive member 174 disposed on the second surface 172 of the second portion 168. The adhesive member 174 is adapted to removably couple the base member 154 with the support structure 110. It should be noted that the adhesive member 174 may anchor the dispensing structure 102 and may allow single handed dispensing of the notes 130 through the slot 138 from any desired direction. The adhesive member 174 includes at least one reusable adhesive tape 176. In the illustrated embodiment, the adhesive member 174 includes four reusable adhesive tapes 176. The number of adhesive tapes 176 may vary as per requirements. In some embodiments, the adhesive member 174 may include a single continuous adhesive tape. In other embodiments, usage of rubber caps, suction cups, or circular rubber pads may be contemplated to couple the base member 154 with the support structure 110.

As illustrated in FIG. 4, when the housing member 112 receives the stack 124 having a maximum permissible number of the notes 130, the first portion 156 of the base member 154 engages with the second retention member 140, more particularly, the tabs 164 of the first portion 156 engage with the inner surface 142 of the second retention member 140. In some examples, the first portion 156 may exert an upward force on the notes 130 such that the stack 124 is retained between the first retention member 132 and the first portion 156. As illustrated, when the housing member 112 receives the stack 124 having the maximum permissible number of the notes 130, the dispensing structure 102 defines a first height “H1”. Further, based on removal of the notes 130 from the stack 124 the first height “H1” reduces.

Referring now to FIG. 5, the housing member 112 moves towards the second portion 168 due to gravity based on removal of the notes 130 from the stack 124. Further, the movement of the second retention member 140 towards the second portion 168 disengages the tabs 164 from the inner surface 142 of the second retention member 140. The movement of the housing member 112 towards the second portion 168 allows a single note 130 to advance against the slot 138 thereby allowing dispensing of the single note 130 at a time and preventing double dispensing. Moreover, a descend of the housing member 112 helps in retention of the remaining notes 130 of the stack 124 proximate the first retention member 132 so that a new top note 130 remains available at the slot 138. The housing member 112 can move towards the second portion 168 until the circular extension 150 of the housing member 112 contacts the second portion 168. Thus, the circular extension 150 acts as a limit stop to eliminate any direct contact between the outer surface 144 of the second retention member 140 and the base member 154.

In some embodiments, the housing member 112 and the base member 154 may be manufactured by three-dimensional printing. Further, the dispensing assembly 100 may be made up of a material such as plastic. A type of the material of the dispensing structure 102 may be selected such that the dispensing structure 102 is light in weight.

The dispensing structure 102 described herein provides a self-pop-up feature that allows single dispensing of the notes 106 (see FIG. 1), the notes 130, or the flags 108 (see FIG. 2). It should be noted that various dimensions of the dispensing structure 102 may vary based on application requirements to accommodate different types/dimensions of stacks. The dispensing structure 102 includes minimum components, and more specifically a two-piece assembly, which may in turn provides a cost-effective device. The dispensing structure 102 includes a simplified design and may be easy to manufacture. Further, the dispensing structure 102 described herein may be light in weight, compact in size, and comfortable to use

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A dispensing structure adapted to be removably coupled with a support structure, the dispensing structure comprising:
a housing member defining a hollow space adapted to receive a stack of a plurality of at least one of notes and flags removably adhered to each other, the housing member including:
a first retention member including a first plate and a second plate longitudinally spaced apart from the first plate such that a slot is defined therebetween, wherein at least one of the notes and the flags of the stack is adapted to pass through the slot, and wherein the first plate and the second plate resiliently engage with the stack; and
a second retention member defining an aperture therethrough, the second retention member being laterally spaced apart from the first retention member to define the hollow space therebetween; and
a base member adapted to be coupled to the housing member, wherein the housing member is adapted to rotate relative to the base member, the base member including:
a first portion slidably received at least partially through the aperture of the second retention member, the first portion defining a first end proximate the stack and a second end distal to the stack; and
a second portion disposed on the support structure and coupled to the first portion proximate the second end of the first portion, wherein the second retention member is adapted to move towards the second portion based on removal of at least one of the notes and the flags from the stack.

2. The dispensing structure of claim 1, wherein the housing member includes at least one side opening in communication with the hollow space for receiving the stack therethrough.

3. The dispensing structure of claim 1, wherein the housing member includes a pair of side members adapted to connect the first retention member with the second retention member.

4. The dispensing structure of claim 1, wherein the first portion of the base member is adapted to contact the stack proximate the first end of the first portion, such that the stack is at least partially disposed between the first portion and the first retention member.

5. The dispensing structure of claim 1, wherein the first portion includes a plurality of tabs disposed proximate the first end of the first portion.

6. The dispensing structure of claim 5, wherein the plurality of tabs engage with the second retention member when the stack is disposed within the hollow space, and wherein the plurality of tabs disengage from the second retention member upon movement of the second retention member towards the second portion of the base member.

7. (canceled)

8. The dispensing structure of claim 1, wherein the first portion is cylindrical in shape, the second portion is circular in shape, or both.

9. (canceled)

10. The dispensing structure of claim 1, wherein the second portion defines a first surface and a second surface, the first surface being adapted to face the second retention member when the base member is coupled to the housing member.

11. The dispensing structure of claim 10 further comprising an adhesive member disposed on the second surface of the second portion, the adhesive member being adapted to removably couple the base member with the support structure, wherein the adhesive member optionally includes at least one reusable adhesive tape.

12. (canceled)

13. A dispensing assembly comprising:
a dispensing structure adapted to be removably coupled with a support structure, the dispensing structure comprising:
a housing member defining a hollow space, the housing member including:
a first retention member including a first plate and a second plate longitudinally spaced apart from the first plate such that a slot is defined therebetween, and wherein the first plate and the second plate resiliently engage with the stack; and
a second retention member defining an aperture therethrough, the second retention member being laterally spaced apart from the first retention member to define the hollow space and at least one side opening therebetween, wherein the at least one side opening is in communication with the hollow space; and
a base member adapted to be coupled to the housing member, the base member including:
a first portion slidably received at least partially through the aperture of the second retention member, the first portion defining a first end proximate the stack and a second end distal to the stack; and
a second portion disposed on the support structure and coupled to the first portion proximate the second end of the first portion; and
a stack of a plurality of at least one of notes and flags removably adhered to each other, wherein the stack is adapted to be received within the hollow space defined between the first retention member and the second retention member through the at least one side opening.

14. The dispensing assembly of claim 13, wherein at least one of the notes and the flags of the stack is adapted to pass through the slot defined between the first plate and the second plate.

15. The dispensing assembly of claim 13, wherein the housing member includes a pair of side members adapted to connect the first retention member with the second retention member.

16. The dispensing assembly of claim 13, wherein the housing member is adapted to rotate relative to the base member.

17. The dispensing assembly of claim 13, wherein the second retention member is adapted to move towards the second portion of the base member based on removal of at least one of the notes and the flags from the stack.

18. The dispensing assembly of claim 13, wherein the first portion of the base member is adapted to contact the stack proximate the first end of the first portion, such that the stack is at least partially disposed between the first portion and the first retention member.

19. The dispensing assembly of claim 13, wherein the first portion includes a plurality of tabs disposed proximate the first end of the first portion.

20. The dispensing assembly of claim 19, wherein the plurality of tabs engage with the second retention member when the stack is disposed within the hollow space, and wherein the plurality of tabs disengage from the second retention member upon movement of the second retention member towards the second portion of the base member.

21. (canceled)

22. The dispensing assembly of claim 13, wherein the first portion is cylindrical in shape, the second portion is circular in shape, or both.

23. (canceled)

24. The dispensing assembly of claim 13, wherein the second portion defines a first surface and a second surface, the first surface being adapted to face the second retention member when the base member is coupled to the housing member.

25. The dispensing assembly of claim 24 further comprising an adhesive member disposed on the second surface of the second portion, the adhesive member being adapted to removably couple the base member with the support structure, wherein the adhesive member optionally includes at least one reusable adhesive tape.

26. (canceled)
